(19) United States
(12) Patent Application Publication
(10) Pub. No.: US 2009/0084760 A1
(43) Pub. Date: Apr. 2, 2009

(54) METHOD FOR REMOVING MATERIAL FROM SOLIDS AND USE THEREOF

(75) Inventors: Kuno Mayer, Freiburg (DE); Daniel Kray, Freiburg (DE); Bernd O. Kolbesen, Bad Homburg (DE); Sybille Hopman, Mahlberg (DE)

Correspondence Address: LEYDIG VOIT & MAYER, LTD, TWO PRUDENTIAL PLAZA, SUITE 4900, 180 NORTH STETSON AVENUE, CHICAGO, IL, 60601-6731, US

(73) Assignees: FRAUNHOFER-SESELLSCHAFT ZUR FORDERUNG DER ANGEWANDTEN FORSCHUNG E.V., MUNCHEN (DE); JOHANN WOLFGANG GOETHE-UNIVERSITAT FRANKFURT AM MAIN, FRANKFURT AM MAIN (DE)

(21) Appl. No.: 12/161,887

(22) PCT Filed: Jan. 25, 2007
(86) PCT No.: PCT/EP07/00642

§ 371 Date: Oct. 8, 2008

(30) Foreign Application Priority Data
Jan. 25, 2006 (DE) 10 2006 003 605.0
Jan. 25, 2006 (DE) 10 2006 003 608.5

(51) Int. Cl. B44C 1/22

(52) U.S. Cl. 216/94

(57) ABSTRACT

The invention relates to a method for material removal on solid bodies, in particular for microstructuring and cutting, by means of liquid jet-guided laser etching, the removed material just as the non-reacted etching components being recycled to a high degree. In this way, silicon with high purity can be recovered either in a polycrystalline manner or be deposited epitaxially on other substrates in the same process chain.

The invention relates to a method for material removal on solid bodies, in particular for microstructuring and cutting, by means of liquid jet-guided laser etching, the removed material just as non-reacted etch components being recycled to a high degree. In this way, silicon with high purity can be recovered either in a polycrystalline manner or be deposited epitaxially on other substrates in the same process chain.

Various methods are already known in which silicon or other materials are etched with the help of a laser or are removed by ablation, with the aim of microstructuring the surface of the materials (U.S. Pat. No. 5,912,186 A). Likewise, the concept of a liquid jet-guided laser is known from EP 0 762 974 B1, here water being used as liquid medium. The water jet serves here as conducting medium for the laser beam and as coolant for the edges of the places on the substrate to be processed, the aim of reducing damage by thermal tension in the material being pursued. With liquid jet-guided lasers, deeper and somewhat cleaner cut grooves are achieved than with “dry” lasers. Also the problem of constant refocusing of the laser beam with increasing groove depth is resolved with lasers coupled in the liquid jet. However with the described systems, lateral damage still occurs to some extent and requires further material removal on the processed surfaces, which both makes the entire process of material processing complex and also leads to additional material loss and hence increased costs.

The standard microstructuring processes with respect to precision and lateral damage, which operate on the basis of photolithographically defined etching masks, are superior to laser-supported methods but are much more complex and significantly slower than these.

Methods are likewise known from the state of the art in which laser light is applied to excite etching media both in gaseous and in liquid form over the substrate. Different materials, e.g. potassium hydroxide solutions of different concentration, serve here as etching media (von Gutfeld, R. J./Hodgson, R. T.: “Laser enhanced etching in KOH” in: Appl. Phys. Lett., Vol. 40(4), 352-354, 15 Feb. (1982)) as far as liquid or gaseous halogenated hydrocarbons, in particular bromomethane, chloromethane or trifluoroiodomethane (Ehrlich, D. J./Osgood, R. M./Deutsch, T. F.: “Laser-induced microscopic etching of GaAs and InP” in: Appl. Phys. Lett., Vol 36(8), 698-700, 15 Apr. (1980)).

Experiments in this respect have been restricted to date however exclusively to the surface processing of the substrates. Deep cuts or in fact cutting of wafers from an ingot with the help of lasers and etching media has to date still not been considered. The occurring etching products have to date not been reprocessed.

On a large industrial scale, silicon wafers are currently produced practically exclusively with one method, multi-wire slurry sawing. The silicon blocks are thereby severed mechanically abrasively by means of moving wires which are wetted with a grinding emulsion (e.g. PEG+SiC particles). Since the cutting wire, which can be a few hundred kilometres long, is wound multiple times around grooved wire guide rollers, many hundreds of wafers can be cut at the same time with the resulting wire field.

In addition to the large material loss of approx. 50%, caused by the relatively wide cut notch, this method has yet a further serious disadvantage. Because of the mechanical effect of the cutting wire and of the abrasive materials during sawing, considerable damage occurs here also in the crystalline structure on the surfaces of the cut semiconductor discs, which thereafter require further chemical material removal.

The deposition of polycrystalline silicon from a gas mixture comprising halogenated silicon compounds, for instance trichlorosilane, and hydrogen is a method which has been known and tested already for a long time from the process chain of large industrial production of ultrapure silicon for semiconductor chip technology.

Starting herefrom, it was the object of the present invention to provide a method which enables material removal on solid bodies, crystal damage to the solid material being intended to be avoided and as high as possible re-use of the removed material being achieved.

This object is achieved by the method having the features of claim 1 and also the use thereof having the features of claim 31. The further dependent claims reveal advantageous developments.

According to the invention, a method is provided for material removal on solid bodies, which is based on the following steps:
a) Firstly, the solid body is treated with a liquid jet-guided laser. The liquid jet hereby used thereby comprises an etching medium for the solid body which comprises at least one halogenating agent.
b) Following thereon, isolation of halogen-containing compounds of the solid material is effected by distillation, condensation and/or cryofocusing from the etching products.
c) In a further step, the solid material is recycled in that the gaseous, halogen-containing compounds are decomposed.

The present method combines various techniques (liquid jet-guided laser etching, polycrystalline silicon deposition, recycling) into a new closed total process. It combines rapid material removal with a laser with the gentle removal of material by means of a chemical etching, the removed material being dissolved in the etching medium or being converted into gaseous compounds. Differently from the case of surface melting or a mechanical effect, the crystalline structure of the substrate is thereby not damaged.

As a result of a recycling system which is connected to the reaction chamber in which the laser etching is effected, not only the non-reacted etching products but also the removed silicon are partially recovered again. The quantity lost of non-used silicon is consequently drastically reduced.

In a preferred variant of the method, the etching medium is selected from the group consisting of water-free, halogen-containing organic or inorganic compounds and mixtures thereof. There are included herein for example fluorinated, chlorinated, brominated or iodised hydrocarbons, the hydrocarbons being straight-chain or branched C₁-C₁₂ hydrocarbons. Particularly preferred representatives are tetrachlorocarbon, chloroform, bromoform, dichloromethane, dichloroacetic acid, acetyl chloride and/or mixtures hereof.

According to the selected etching medium, all wavelengths of the infrared range up to the UV range serve for chemical excitation, IR lasers exciting predominantly but not exclusively thermochemically, UV lasers exciting predominantly but not exclusively photochemically. The chemical excitation is based predominantly on the homolytic splitting of the halogen compounds, very reactive halogen or hydrocarbon radicals being formed which etch the silicon at high speed and are superior to ionic etching media in their etching effect. It is likewise possible to use green lasers with an emission in the green range of the spectrum, i.e. at approx. 532 mm.

### Examples of Chemical Excitations:

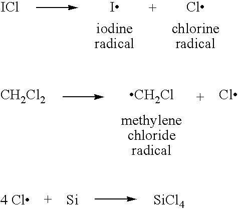

The etching effect is effected practically non-selectively with respect to specific crystal orientations. Recombination of radicals frequently leads to likewise very reactive materials which can remove silicon directly at a high etching rate. This reaction is effected corresponding to the subsequent equations.

2Cl.→Cl₂

2Cl₂+SiSiCl₄

This fact and also the existence of a radical chain reaction ensure continuous and relatively constant high removal of the silicon.

There are formed as etching products e.g. silanes of different compositions which are halogenated multiple times, halogenated short-chain hydrocarbons of different compositions and also SiC and C in a very small quantity, which are all present in addition to not yet reacted starting materials. Examples of halogenated silanes are SiCl₄, SiHCl₃, SiH₂Cl₂, SiBr₄, SiHBr₃, SiI₄ and SiBr₂Cl₂. Examples of halogenated hydrocarbons are CH₂CI—CHCl₂, CHCl₂—CHCl₂, CHBrCl—CHCl₂, CH₂I—CH₂CI, CCl₂═CHCl, C₆Cl₆ and C₂Cl₆.

Furthermore, it is preferred that the etching products are subjected to a catalytic hydrohalogenation with formation of gaseous and halogen-containing saturated compounds.

The catalytic hydrohalogenation is effected preferably with hydrogen chloride and platinum as catalyst.

The gaseous, halogen-containing and saturated compounds which are formed during the hydrohalogenation are cryofocused and/or condensed in a preferred variant before recycling, i.e. before decomposition of this compound.

In order to make possible a closed process chain, preferably the hydrogen halides produced in step c) are supplied again to the hydrohalogenation in step b).

It is preferred in many cases—according to the choice of etching mixture—to enrich the atmosphere in the processing chamber with defined quantities of dry oxygen or dry air (as oxygen provider). Oxygen increases not only the etching rate of some etching mixtures in specific cases in that it forms reactive intermediate products with these but also prevents the undesired deposition of carbon-halogen polymers or carbon particles on the substrate in that it oxidises these waste products immediately during production thereof. Free oxygen must however by removed again from the system before further processing of the etching products since it impedes the following process steps or makes them impossible. For example, it would form a (highly explosive) oxyhydrogen gas mixture together with the hydrogen introduced there in the subsystem VIII. During condensing-out or freezing-out of the etching products in subsystem V, pure oxygen can be suctioned from these and recycled again likewise in part (not illustrated in the accompanying design sketch) since its boiling point is lower by a multiple than the boiling points of almost all other substances present in the system, with the exception of carbon monoxide which likewise is jointly suctioned off.

If the operation takes place with oxygen additions, then phosgene is produced inter alia as waste product. This is in equilibrium with carbon monoxide and chlorine from which it is formed at temperatures up to 300° C. Above this temperature, a complete decomposition into the starting materials takes place. Decomposition is promoted by the presence of oxygen (oxidation of the phosgene into CO₂ and chlorine). This fact can be used for decomposition thereof.

A further variant according to the invention provides that, in step a) and/or between steps a) and b), partial hydrohalogenation is implemented by the addition of a hydrogen halide. The introduction of the hydrogen halide can thereby be effected in the processing chamber, the intermediate stores and/or the tanks. Relative to the previously-described variant in which oxygen is used, it is advantageous that the formation of phosgene is substantially suppressed. The formation of disruptive polymers from the unsaturated halogen-carbon-(hydrogen-) compounds is prevented in that the unsaturated compounds are saturated immediately during formation thereof with the hydrogen halide and hence can no longer polymerise to an adverse degree.

A further variant of the method according to the invention is based on the fact that a carbon-free halogenating agent is used as etching medium, which represents a practicable and economical alternative to carbon-containing halogen sources which are frequently ozone-damaging. According to the method according to the invention, no particular legal handling regulations require hence to be observed, which significantly simplifies the process chain. A further essential advantage of the method according to the invention is based on the low-waste processing possibility of solid bodies, in which the large part of the removed solid material can be recycled. Furthermore, the formation of halogen-containing hydrocarbons and polymers derived therefrom is prevented. A further substantial advantage of the method according to the invention is based on the fact that polycrystalline silicon can be recovered, without it being contaminated by silicon carbide.

Surprisingly, it was able to be shown in addition that the halogenating agents used according to the invention provide a significantly higher yield of effectively usable halogens and hence make the entire process significantly more economical. This relates likewise to the more effective use of the radiated laser energy associated with the method according to the invention. This is achieved by the use of absorber materials in conjunction with the halogenating agents used according to the invention, as a result of which the palette of laser radiation which can be used for the process is extended.

Preferably, the halogenating agent is selected from the group of halogen-containing sulphur and/or phosphorus compounds. There are included herein in particular sulphuryl chloride, thionyl chloride, sulphur dichloride, disulphur dichloride, phosphorus trichloride, phosphorus pentachloride and mixtures thereof.

A further preferred variant provides that a mixture of nitric acid as first component and also hydrofluoric acid, ammonium fluoride or ammonium bifluoride as second component is used as etching medium in an aqueous or organic solvent. For example water or glacial acetic acid are preferred here as solvent. Glacial acetic acid has the advantage relative to water that any forming volatile but hydrolysis-sensitive SiF₄ or SiF₆ can be isolated better. The proportion of hydrofluoric acid in the mixture is preferably from 1 to 20% by weight. Relative to chlorine-containing halogenating agents, the fluorine-containing halogenating agents have the advantage of a higher etching rate, however the disadvantage relative to these being that the removed silicon is more difficult to recover because of the special stability of Si—F bond. Silicon fluorides, such as SiF₄ and SiF₆, in particular if they are isolated water- and oxygen-free, can however be used as useful synthesis chemicals in organosilicon chemistry. The handling of mixtures of hydrofluoric acid and nitric acid makes particular technical demands on the apparatus. These must have a particularly high corrosion resistance, in particular relative to hydrofluoric acid. All the pressure-resistant components, e.g. the optical head of the processing device or the line between pump and laser coupling unit, are preferably configured from Hastelloy steels and are provided with a hydrofluoric acid-resistant coating. This hydrofluoric acid-resistant coating preferably comprises a copolymer made of ethylene and chlorotrifluoroethylene, also known under E-CTFE. In the cases in which no high thermal stressability or very high pressure resistance is required, such as e.g. in the processing chamber, preferably polytetrafluoroethylene is used as hydrofluoric acid-resistant coating.

In a further preferred variant of the method according to the invention, it is provided that the etching medium comprises in addition elementary halogens in liquid form, e.g. bromine and iodine, and/or interhalogen compounds, e.g. iodine monochloride or iodine trichloride.

A further preferred variant of the method according to the invention provides that the etching medium contains in addition a strong Lewis acid, such as e.g. boron trichloride and aluminium trichloride. As a result of these additions, the tendency of the etching media to decompose under specific conditions, e.g. for sulphuryl chloride and thionyl chloride, can be increased and hence the reactivity of the etching medium can be increased.

Preferably, the halogenating agents are activated thermally or photochemically. This excitation can thereby be initiated by the laser used according to the invention. A preferred variant hereby provides that a laser with an emission in the UV range is used and thus an essentially photochemical activation of the etching medium is effected. A second preferred variant provides that the laser with an emission in the IR range is used and thus an essentially thermochemical activation of the etching medium is effected. It is likewise possible to use a laser with an emission in the green range of the spectrum, in particular at 532 nm, an essentially photochemical activation being effected. Likewise, a laser with an emission in the blue range of the spectrum, in particular at 457 nm, can be used, an essentially photochemical activation being effected here also.

In order that the radiated laser energy can be used effectively, it is preferred to add in addition radiation absorbers to the etching medium, which absorb the radiated electromagnetic radiation in part and consequently are excited. Upon returning to the basic state, the available energy is transmitted to specific components of the etching medium or of the solid body to be processed, which, for their part, are consequently excited and hence become more reactive. The spectrum of the excitation form extends hereby from a purely thermal to a purely chemical (electron transfer) excitation. There are used as radiation absorbers preferably colourants, in particular eosine, fluorescein, phenolphthalein, Bengal pink, as adsorbers in the visible range of light. There are used as UV absorbers preferably polycyclic aromatic compounds, e.g. pyrene and naphthacene. In addition to an increase in the effective use of the radiated energy, a broader spectrum of usable radiation for the method according to the invention is provided by the radiation absorbers.

Activation of the halogenating agents can also be effected by a radical route by addition of radical starters, e.g. dibenzoyl peroxide or azoisobutyronitrile (AIBN) which are added to the etching medium.

The etching products formed during the method according to the invention can be present in liquid and in gaseous form. The gaseous etching products are thereby preferably cryofocused and/or condensed, whereas the liquid etching products are preferably separated by distillation.

The solid body preferably concerns a silicon disc, e.g. in the form of a wafer. In the case where the solid body comprises silicon, a halogenated silane compound is present as gaseous and halogen-containing compound. These can then be decomposed subsequently into polycrystalline silicon and hydrogen halide. The decomposition is thereby effected preferably according to methods known from the state of the art, e.g. the Siemens method. The halogenated silane compound is hereby thermally decomposed on a heated ultrapure silicon bar in the presence of hydrogen, the elementary silicon being grown on the bars.

However, it is likewise also possible that the silicon is deposited epitaxially in the process chain.

When using halogen-sulphur-(oxygen-) compounds as halogen source and/or solvent, such as for example sulphuryl- or thionyl chloride, the technical construction of the entire system is considerably reduced. This can be attributed to the following three chemical characteristics of sulphur and its compounds:
1. Sulphur and its compounds present in the system do not, under the given conditions, form any unsaturated compounds, such as for instance carbon-halogen-(hydrogen-) compounds which tend towards polymerisation.
2. Sulphur and its compounds present in the system do not, under the given conditions, represent a serious contamination source for the silicon to be processed or redeposited.
3. The waste products produced during the process do not require any special handling (for instance a closed circulation) because of their changed risk potential in comparison with carbon-halogen-(hydrogen-) compounds (which are in part greatly ozone-damaging, such as for example tetrachlorocarbon).

According to the choice of reaction conditions, doping of the solid body surface with elements of the main group III, V and VI can also be implemented with the method according to the invention in parallel or temporally offset to material removal. Particularly preferred doping elements here are boron, phosphorus and sulphur. However all the doping agents for the respective solid material known from the state of the art can also be used.

The present method enables rapid, simple and economical processing of solid bodies, in particular made of silicon, e.g. microstructuring or also cutting of silicon blocks into individual wafers. The structuring step does not introduce crystal damage into the solid material so that the solid bodies or cut wafers require no wet-chemical damage etch which is normal for the state of the art. In addition, the previously occurring cut waste is re-used via a connected recycling device so that the total cut loss can be drastically reduced, in particular during wafer cutting (e.g. by 90%). This has an immediately minimising effect on the production costs of the silicon components processed in this way, such as e.g. on the still relatively high production costs for solar cells.

The method according to the invention, as mentioned already, can be applied to any solid bodies as long as the chemical system which is used develops a similar etching effect.

With reference to the subsequent Figures, the subject according to the invention is intended to be explained in more detail without wishing to restrict the latter to the special embodiment shown here.

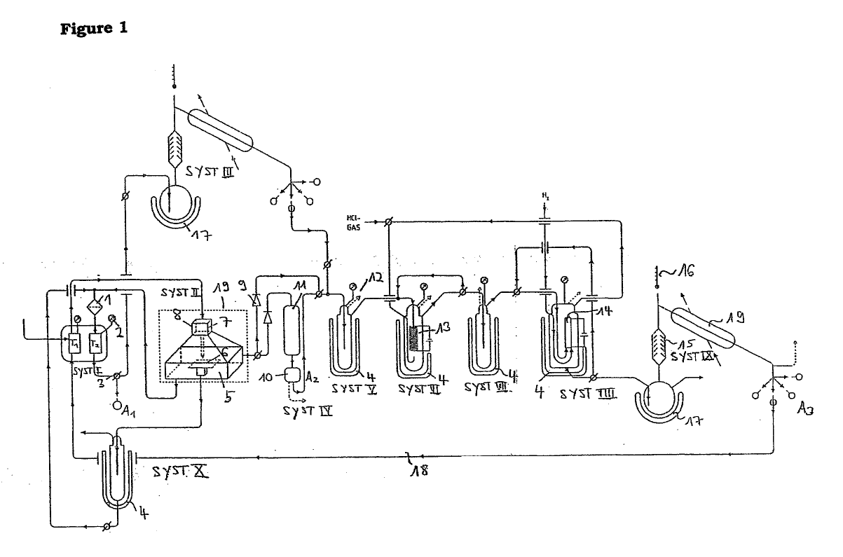

FIG. 1 shows, with reference to a schematic representation, the method course according to the invention when using halogen-containing hydrocarbons.

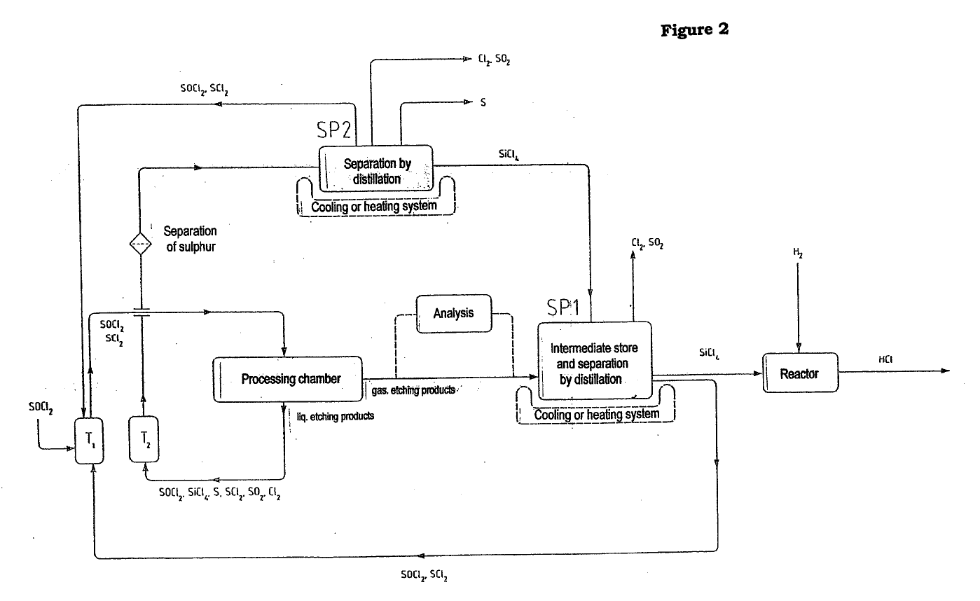

FIG. 2 shows, with reference to a schematic representation, the method course according to the invention when using halogen-containing sulphur compounds as etching medium.

The apparatus represented in FIG. 1 comprises 10 sub-systems. The following tasks are allocated thereby to the individual sub-systems.
System I: Storing the etching media
System II: Semiconductor processing (cutting, microstructuring)
System III: Fractionation of liquid etching products from the reaction chamber
System IV: Separation and analysis of volatile etching products directly from the reaction chamber
System V: 1. Intermediate storage of the etching products (unsaturated products still possible here); the gas supply in system VI is metered carefully by cooling or heating
System VI: Catalytic hydrohalogenation of unsaturated products
System VII: 2. Intermediate storage of the now saturated etching products
System VIII: Decomposition of halogen-containing silicon compounds with formation of hydrogen halide which is recycled in order to saturate the unsaturated etching products
System IX: Fractionated separation of non-reacted etching products; recycling halogen-containing hydrocarbons, these are transferred into tank T₁
System X: Protective system for vacuum pump

The core components of the first sub-system (system I) are two chemical tanks T₁ and T₂. T₁ serves for storing fresh etching media and also distilled-off readily volatile etching products, such as e.g. recycled halogenated hydrocarbons. Halogenated silicon compounds are not contained here or only in traces. In T₂, non-reacted liquid etching media and also liquid or dissolved etching products, such as e.g. halogenated silanes, are stored. T₂ is supplied directly with the outflowing liquid from the reaction chamber, any solid particles contained in the liquid being removed before entering the tank by means of a μm filter. Furthermore, sub-system I has a manometer 2 and an analysis station A₁ connected via a three-way cock 3 for analysis of the liquid etching products from the reaction chamber.

Sub-system II (system II) comprises a reaction chamber 5 which is situated on an x-y table, not illustrated. It comprises inert plastic materials, such as for example Teflon or PE, or comprises stainless steel. The chamber is sealed hermetically to the exterior, free of moisture and—according to the embodiment—also free of oxygen and also possibly flooded during the process with dried nitrogen or with another inert gas. In the reaction chamber, the silicon wafer or ingot to be processed is retained by a chuck 6, suctioned on with the help of a vacuum pump. The reaction chamber has an outflow which conducts the discharging liquid via a filter 1 into tank T₂. The gases produced during the removal (etching or ablation) are conducted via a suction mechanism from the chamber into sub-system IV (system IV), a throttle valve 9 being connected intermediately, or are transferred directly into sub-system V via a three-way cock. In addition, the reaction chamber has a camera 5.

Processing of the silicon wafer or ingot, e.g. cutting or microstructuring thereof, is effected with the help of a liquid jet-guided laser 7. The liquid jet serves as etching medium for the silicon, the laser activates the process photo- or thermochemically and enables precise structuring of the workpiece. The laser beam can remove the silicon however also by ablation, then the silicon reacting further only in the subsequent step with the liquid components, compounds analogous to the etching process being formed.

The products are frozen out or condensed in sub-system V which serves as first intermediate store of the process chain. In addition, sub-system V has an excess pressure valve 12. The etching products present in liquid form at room temperature are separated by distillation firstly in sub-system III after collection in tank T₂ and the individual fractions, according to increasing boiling point, are transferred gradually into sub-system V.

Sub-system IV, which precedes sub-system V, comprises a material separating unit 11, in the present case a gas chromatograph and an analysis device 10, e.g. an IR or RAMAN measuring unit, for determining the components of the gaseous etching product mixture. This sub-system can be used only temporarily or optionally—according to requirement; it can be bridged via a bypass. Two throttle valves prevent any possible gas return flow from the following systems back into the reaction chamber.

Sub-system VI (system VI) serves for catalytic hydrohalogenation of still unsaturated etching products, e.g. with the help of HCl gas on a platinum catalyst 13. System VI is supplied slowly, by controlling the cooling and possibly heating, with the frozen-out or condensed materials from system V. It can be segregated from the adjacent sub-systems via three-way cocks. The segregation ensures a longer stay in the chamber of the materials to be saturated and hence an increase in the degree of saturation of the unsaturated etching products.

The now saturated product mixture is collected in sub-system VII, the second intermediate store of the process chain, in that it is again frozen out or condensed by nitrogen cooling.

In sub-system VIII, finally the halogenated silicon compounds, e.g. trichlorosilane or silicon tetrachloride, are decomposed analogously to the cleaning step of the silicon during large scale industrial ultrapure silicon production in the presence of hydrogen on a silicon bar 14, which is heated by a current throughflow, into polycrystalline silicon and hydrogen halides. The hydrogen halides are used for catalytic hydrohalogenation of the unsaturated etching products occurring during the removal process. In addition to the variant described here, also a direct epitaxial deposition of silicon on various substrates or other normal silicon product methods, such as for example fluidised bed reactors, are however possible as sub-system VIII.

System VIII can also be segregated relative to the adjacent systems, likewise with the aim of increasing the dwell time of the reacting materials in the chamber and hence the conversion degree thereof.

Non-reacted materials can be frozen out or condensed out after completion of the reaction and be conducted finally into sub-system IX where separation by distillation of the residues, in the present case by means of a system comprising a Vigreux column 15, a thermometer 16, a cooling or heating device 17 and a cooler 19, is effected. Any halogenated hydrocarbons possibly still present can then be transferred again via the gas pipe 18 into tank T₁.

Sub-system X is a pure protection system for the vacuum pump required for suctioning on of the workpiece. However in the course of the process, significant quantities of liquid etching products above all are also suctioned in here and can be transferred into tank T₂ after a filtration. Sub-system X hereby has a cooling or heating device 4.

The apparatus provides in total three options (A1, A2, A3) for analysis of the etching mixtures: system IV (A2) thereby serves for analysis of gaseous etching products, system IX (A3) enables non-reacted components to be drawn off in general and cock A1 enables determination of the composition of the tank T₂.

For sub-systems III and IX, other separation methods are also conceivable in addition to distillation, e.g. chromatographic methods. Hence—according to requirement—some yet improved material separations can be achieved.

Sub-systems I, V, VI, VII and VIII are provided with manometers and excess pressure valves. The lines between sub-systems II-IX (excluding III) in the process chain are constantly heated to 45° C. in order to prevent condensing-out of the solvent dichloromethane.

A further variant provides that halogenated carbons or hydrocarbons are used as solvent or halogen source. In this case, the method principle represented in the Figure can also be applied, the following modifications occurring:
1. Dry HCl gas of a defined quantity is conducted into the sub-systems, system II and system V and also tank T₂. Instead, the introduction of oxygen into the apparatus is dispensed with.
2. Before the decomposition of the product mixture in system VIII, the silane compounds are separated completely from the carbon-containing components by distillation. The latter are not conducted through system VIII, either before, during or after the decomposition of the silanes.

With the first measure, the problem is intended to be taken into account that the unsaturated halogenated carbon-(hydrogen)-compounds and silanes which are produced during a rapid etching process tend in part towards polymerisation.

In this variant, polymerisation of the unsaturated etching products is prevented by early saturation of these materials, for example by reaction with HCl, in that the latter is conducted in gaseous form both via the condensed-out gaseous etching products into sub-system V and also by the liquid etching products into tank T₂, in addition the processing chamber (system II) also in a small quantity. The introduction which is directed directly towards the processing place is effected here through a nozzle. Irradiation of the material mixtures with light of a defined wavelength, for example with UV light, can accelerate the saturation process. This method circumvents the disadvantages of an oxygen contamination of the product mixture.

The broad etching attack of the HCl gas on the substrate surface in the processing chamber is prevented by a thin liquid film which is formed on the surface of the substrate during processing.

With the second measure, the following is achieved. If the entire process is operated as set out in the above-mentioned patent application, then, in sub-system VIII, there results, in addition to deposition of polycrystalline silicon, also deposition of significant quantities of silicon carbide which contaminates the silicon. The deposition of silicon carbide can but need not necessarily be desired. Silicon carbide is useful for example as the main component of a passivation layer for solar cells.

If however, ultrapure polycrystalline silicon is intended to be deposited, then it is sensible completely to separate any carbon-halogen compounds present in the etching product by distillation from the silane compounds even before decomposition thereof in sub-system VIII.

The essential components of the system according to the invention represented in FIG. 2 are two tanks for storage of etching media T₁ and T₂, the processing chamber, an intermediate store SP1 which serves for separation by distillation of the gaseous etching products and an SP2 in which the intermediate storage and separation of the liquid etching products takes place. Furthermore, the entire system comprises a deposition reactor in which for example polycrystalline silicon from SiCl₄, which represents one of the etching products, can be deposited again.

Tank T₁ serves as supply tank for externally supplied thionyl chloride (SOCl₂) or sulphuryl chloride (SO₂Cl₂). This is split either thermally or photochemically by laser light in the processing chamber. Thermal splitting is effected for example using an Nd:YAG laser, the thermal decomposition then being effected on the heated surface of the substrate. It takes place already at temperatures only insignificantly higher than the boiling points of the compounds (boiling point of SOClᵢₛ 76° C., decomposition of SO₂Cl₂ is effected already from 70° C.), very reactive nascent chlorine gas being produced which serves as actual etching medium for the silicon:

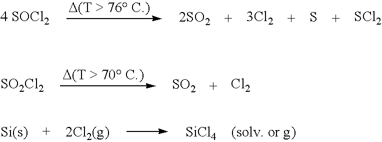

A radical decomposition of the halogen source takes place with the help of a UV laser, very reactive chlorine radicals being formed which react further directly with the silicon to form SiCl₄:

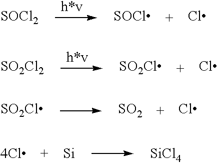

(“.” symbolises an unpaired electron, SOCl., SO₂Cl. and Cl. are accordingly radicals). By the addition of absorber materials and/or radical starters which can be activated, for their part, by laser light of the most varied of wavelengths, the operation can take place effectively also with lasers in other wavelength ranges.

The resulting, low-boiling silicon tetrachloride leaves the processing chamber either by a gaseous route together with the gaseous etching products, said silicon tetrachloride being frozen out in SP1 with the same, or by a liquid route, being introduced into tank T₂ together with the other liquid wastes of the processing process, the largest fraction of which is non-reacted SOCl₂ or SO₂Cl₂.

In SP1, the SiCl₄ is separated by distillation from the remaining components. SO₂ and Cl₂ are under standard conditions gases and can be suctioned off very easily. For example the boiling points of SOCl_{and SiCl}₄ differ merely by 18° C., their melting points however by 35° C., which suggests separation of the two materials by freezing out the component which solidifies at higher temperatures (SiCl₄ at −69° C.), as a result of which very clean separation can be effected. However, partial separation by means of distillation is also conceivable. In the gas mixture obtained therefrom and enriched with SiCl₄, the residues of thionyl chloride can then be completely decomposed thermally. The thereby obtained waste products (SO₂, Cl₂, SCl₂ and S) can again be separated very easily from SiCl₄ by distillation. The latter variant has the advantage that an energy-intensive nitrogen or carbon dioxide cooling, which would be necessary for freezing out the components, can thereby be dispensed with, which increases the profitability of the entire process.

The very pure SiCl₄ can then be decomposed in a Siemens reactor with hydrogen introduction to form polycrystalline silicon and hydrogen chloride.

Non-reacted SOCl₂, SO₂Cl₂ and SCl₂ formed during the process are conducted again into tank T₁, from where they are conducted directly again into the processing chamber.

The resulting (waste) gases HCl and SO₂ are conducted into basic aqueous solutions and neutralised or used as starting materials for chemical syntheses. The solid waste product sulphur which is obtained in pure form can be re-used again likewise industrially.

1. A method for removing material on a solid body comprising the steps of:
a) liquid jet-guided laser etching of the solid body with a liquid jet comprising an etching medium comprising at least one halogenating agent to obtain etching products,
b) isolating of halogen-containing compounds of the solid material by distillation, condensation and/or cryofocusing from the etching products and
c) recycling of the solid material by decomposition of the halogen-containing compounds.

2. The method according to claim 1, wherein the halogenating agent is selected from the group consisting of water-free halogen-containing organic or inorganic compounds and mixtures thereof.

3. The method according to claim 2, wherein the halogenating agent is selected from the group of straight-chain or branched C₁-C₁₂ hydrocarbons which are at least partially halogenated.

4. The method according to claim 2, wherein the halogenating agent is selected from the group consisting of tetrachlorocarbon, chloroform, bromoform, dichloromethane and mixtures hereof.

5. The method according to claim 2, wherein the etching products are selected from the group consisting of halogenated silanes, liquid halogenated hydrocarbons, silicon, silicon carbide and mixtures thereof.

6. The method according to claim 2, wherein, in step a), oxygen or a gas comprising oxygen is supplied, which is removed again before step b).

7. The method according to claim 2, wherein the etching products are subjected to a catalytic hydrohalogenation with formation of gaseous and halogen-containing saturated compounds.

8. The method according to claim 7, wherein the hydrohalogenation is implemented with hydrogen chloride and also with a catalyst.

9. The method according to claim 7, wherein recycling of hydrogen halide formed in step c) is effected and the latter is supplied to the hydrohalogenation.

10. The method according to claim 1, wherein the halogenating agent is free of carbon.

11. The method according to claim 10, wherein the halogenating agent is selected from the group of halogen-containing sulphur compounds and halogen-containing phosphorus compounds.

12. The method according to claim 11, wherein the halogenating agent is selected from the group consisting of sulphuryl chloride, thionyl chloride, sulphur dichloride, disulphur dichloride, phosphorus trichloride, phosphorus pentachloride and mixtures thereof.

13. The method according to claim 11, wherein the etching products are selected from the group consisting of halogenated silanes, silicon and mixtures thereof.

14. The method according to claim 1, wherein the etching medium contains in addition at least one radiation adsorber.

15. The method according to claim 14, wherein the radiation adsorber is a colorant.

16. The method according to claim 14, wherein the radiation adsorber is a polycyclic aromatic compound.

17. The method according to claim 1, wherein the etching medium contains in addition at least one radical starter.

18. The method according to claim 17, wherein the radical starter is selected from the group consisting of dibenzoyl peroxide and azoisobutyronitrile.

19. The method according to claim 1, wherein the etching medium comprises in addition elementary halogens in liquid form, interhalogen compounds, or halogenated hydrocarbons in solid form.

20. The method according to claim 1, wherein photo- and/or thermochemical activation of the etching medium is effected by the laser.

21. The method according to claim 1, wherein a laser with an emission in the UV range is used and an essentially photochemical activation of the etching medium is effected.

22. The method according to claim 1, wherein a laser with an emission in the IR range is used and an essentially thermochemical activation of the etching medium is effected.

23. The method according to claim 20, wherein a laser with an emission in the green range of the spectrum is used and an essentially photochemical activation of the etching medium is effected.

24. The method according to claim 20, wherein a laser with an emission in the blue range of the spectrum is used and an essentially photochemical activation of the etching medium is effected.

25. The method according to claim 1, wherein the gaseous etching products that are gaseous are cryofocused and/or condensed.

26. The method according to claim 1, wherein the etching products that are liquid are separated by distillation.

27. The method according to claim 1, wherein the solid body comprises silicon.

28. The method according to claim 27, wherein halogenated silane compounds as etching products are decomposed into polycrystalline silicon and hydrogen halide.

29. The method according claim 28, wherein the decomposition is effected according to the Siemens method.

30. The method according to claim 28, wherein the silicon is deposited epitaxially in the process chain.

31. The method according to claim 1 which involves cutting and/or microstructuring of the solid body.
